(19) United States
(12) Patent Application Publication
(10) Pub. No.: US 2004/0041383 A1
(43) Pub. Date: Mar. 4, 2004

(54) Hybrid gas generator

(75) Inventors: Maximilian Bergmann, Muhldorf (DE); Alexander Gerstner, Waldkraiburg (DE); Nils Henning, Rostock (DE); Jens Holzapfel, Klein Grenz (DE)

Correspondence Address: TAROLLI, SUNDHEIM, COVELL, TUMMINO & SZABO L.L.P., 1111 LEADER BLDG., 526 SUPERIOR AVENUE, CLEVELAND, OH, 44114-1400, US

(73) Assignee: TRW Airbag Systems GmbH

(21) Appl. No.: 10/649,483

(22) Filed: Aug. 27, 2003

(30) Foreign Application Priority Data
Aug. 30, 2002 (DE) 202 13 396.6

(51) Int. Cl. B60R 21/26

(52) U.S. Cl. 280/741

(57) ABSTRACT

A hybrid gas generator comprises a cylindrical outer housing having a longitudinal axis, and a pressure chamber which is filled with compressed gas and closed by a membrane. A pyrotechnic charge is provided for opening the membrane, the charge being accommodated in a preferably bush-shaped charge housing, which has a longitudinal axis arranged substantially at right-angles to the longitudinal axis of the outer housing and extends into the latter. There is also provided an outflow opening in the outer housing. Inside the outer housing there is a separate holding body provided for retaining the charge housing. The holding body is fastened to the charge housing and, additionally, to a part of the gas generator which is not destructed in an activated state of the gas generator.

### TECHNICAL FIELD

The invention relates to a hybrid gas generator.

### BACKGROUND OF THE INVENTION

A hybrid gas generator usually comprises a cylindrical outer housing having a longitudinal axis, a pressure chamber filled with compressed gas and closed by a membrane, a pyrotechnic charge provided for opening the membrane, the charge being housed in a preferably bush-shaped charge housing which has a longitudinal axis arranged substantially at right-angles to the longitudinal axis of the outer housing and extends into the latter, and an outflow opening provided in the outer housing.

A hybrid gas generator of this type is known from EP 1 223 085 A2. The gas generator shown here has a pressure chamber having a longitudinal axis and an igniter housing arranged perpendicularly to this longitudinal axis. Screwed into the igniter housing is an accommodation piece that holds a projectile, which in case of activation destroys a membrane closing the pressure chamber. The accommodation piece also serves as a support for the membrane which is destructed upon by the high internal pressure in the pressure chamber when the gas genarator is activated.

Hybrid gas generators are used for inflating a gas bag or for actuating a belt tensioner, for example. Through the arrangement of the charge housing radially to the longitudinal extent of the preferably elongated outer housing, advantages are produced on installation of the gas generator with regard to the accessibility of the connection contacts of the igniter.

The invention provides a hybrid gas generator which is distinguished by a simple construction.

### BRIEF SUMMARY OF THE INVENTION

According to the invention, a hybrid gas generator comprises a cylindrical outer housing having a longitudinal axis, and a pressure chamber which is filled with compressed gas and closed by a membrane. A pyrotechnic charge is provided for opening the membrane, the charge being accommodated in a preferably bush-shaped charge housing which has a longitudinal axis arranged substantially at right-angles to the longitudinal axis of the outer housing and extends into the latter. There is also provided an outflow opening in the outer housing. Inside the outer housing there is a separate holding body provided for retaining the charge housing. The holding body is fastened to the charge housing and, additionally, to a part of the gas generator which is non-destructed in an activated state of the gas generator.

According to the preferred embodiments, the holding body is fastened to the pressure chamber by means of a membrane holder which defines the non-destructed part in the activated state of the gas generator.

In the hybrid gas generator proposed, the preferably bush-shaped, separate charge housing is inserted radially into the outer housing, a separate part being provided in the form of a holding body provided in the outer housing. This holding body contributes to the positioning of the charge housing, undertakes the positioning alone or merely secures the charge housing. Through the holding body, the charge housing can also be positioned very precisely relative to other parts provided inside the gas generator. In addition, the holding body allows the fastening of the charge housing to the outer housing to be constructed more simply or even to be partially omitted.

Preferably, the holding body engages on the charge housing such that it counteracts a movement thereof in the direction of its longitudinal axis and/or the longitudinal axis of the outer housing or delimits it. In this respect, the holding body can serve for example as a kind of locking arrangement of the charge housing in the direction of the longitudinal axis thereof.

The pressure chamber has an end wall facing the charge housing. Between the charge housing and the end wall, the holding body is provided inside the outer housing. Here, the holding body can serve as a spacer between the membrane which is to be destroyed and the charge housing.

For simplified installation of the membrane, the latter can be fastened to a membrane holder which in turn is arrested on the end wall and surrounds an opening in the end wall which is closed by the membrane.

The holding body can either directly adjoin the end wall or the membrane holder, or engage thereon or be fastened thereon. If it engages on the membrane holder or is fastened to it, smaller cumulative tolerances are produced, whereby the distance between the charge housing and the membrane can be maintained more exactly.

An embodiment makes provision that the pressure chamber is a bottle-shaped container, the peripheral wall of which forms a section of the outer housing of the gas generator and the end face of which forms the previously mentioned end wall to which the holding body is coupled directly or indirectly (e.g. by means of the above-mentioned membrane holder). The bottle-shaped container is therefore a separate, prefabricated unit which fulfils the high demands on a compressed gas container, without adjoining parts having to be produced from equally high-grade material. Often, therefore, a distinct reduction in cost is produced and also a lower weight, because the parts provided outside the container, in particular the parts which form sections of the outer housing, can have a smaller thickness.

In this connection, it is advantageous if a sleeve is provided which is connected with the peripheral wall of the container and forms a further section of the outer housing. In the sleeve, the insertion opening can then be provided and the charge housing can be accommodated.

The sleeve and the container are connected with each other by rolling, for example.

An embodiment makes provision that the charge housing is fastened on a section of the peripheral wall lying diametrically opposite the insertion opening, at least against displacement in the direction of the longitudinal axis of the outer housing. In this connection, the holding body can serve as an additional fastening, locking arrangement or spacer.

The charge housing preferably has at least one opening directed towards the membrane, so that this opening co-determines the alignment of the gas stream emerging from the charge housing.

### BRIEF DESCRIPTION OF THE DRAWINGS

FIG. 1 shows a longitudinal sectional view through an embodiment of the hybrid gas generator according to the invention, and

FIG. 2 shows a detail cut-out in the region of the outflow opening of the gas generator of the invention, in accordance with a second embodiment.

### DETAILED DESCRIPTION OF THE PREFERRED EMBODIMENTS

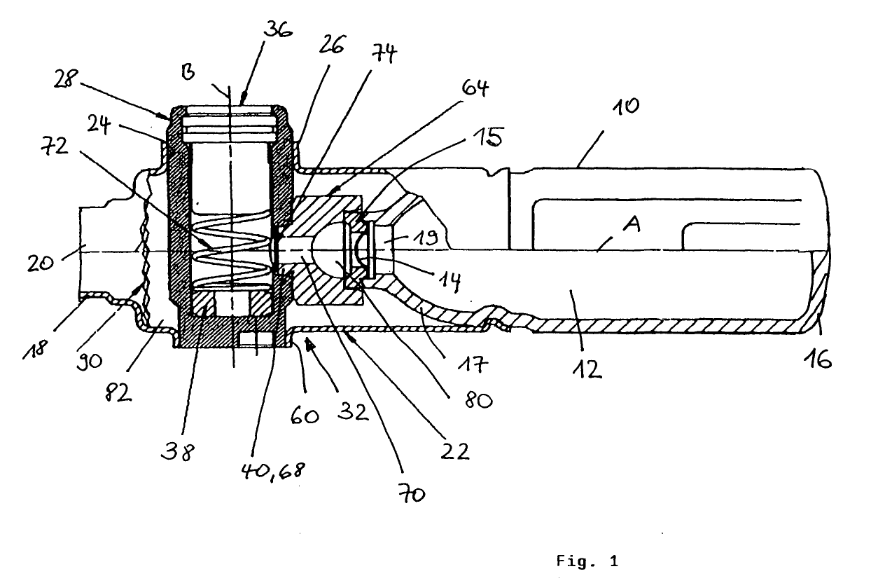

In FIG. 1 a hybrid gas generator is shown, which has an elongated cylindrical outer housing 10 and a pressure chamber 12 filled with compressed gas. The pressure chamber 12 is formed by a bottle-shaped container 16 which has a peripheral wall which forms a section of the peripheral wall of the cylindrical outer housing 10. The container 16 has an end wall 17 with an opening 19 for outflowing gas, which is closed by a membrane 14. The membrane 14 is arrested on a ring-shaped membrane holder 15, which in turn is fastened to the end wall 17 and which defines a part of the gas generator remaining non-destructed in the activated state of the gas generator.

A sleeve 18 is placed on the container 16 on the membrane side end, and is connected with the container 16 by rolling (application of a radial force for deformation) or welding. The sleeve 18 is open on the end face on the end opposed to the membrane 14, the opening forming an axial outflow opening 20. The outer housing thus has an open end face, a closed end face opposite the end wall of the container 16, and a cylindrical peripheral wall 22 defined by the sleeve 18 and the peripheral wall of the container 16.

Close to the membrane 14 and outside the container 16, the sleeve 18 has a radial insertion opening 24, the edge of which is deformed outwards into a cylindrical guide neck 26. The peripheral wall 22 has, on its section 32 lying opposite the insertion opening 24, a through-bore 60 which is in alignment with the insertion opening 24 and preferably is minimally smaller than this.

A bush-shaped charge housing, formed from a separate part, is introduced into the insertion opening 24 into the gas generator. The charge housing 28 also projects into the through-bore 60, which is likewise equipped with a guide neck, and is fixed there with the outer housing 10 by means of a press fit. A press fit can also be provided in the region of the guide neck 26. The two press fits could also be constructed as loose or transition fits, if leakage flows are permitted. In this case, however, the movement of the charge housing 28 out in the insertion direction is only prevented by the holding body 64 which is further described below.

Between the charge housing 28 and the end wall 17, a holding body 64 is provided inside the outer housing 10, which holding body 64 lies on the one hand against the end face of the membrane holder 66 and on the other hand is inserted with a slightly tapered extension 68 into a radial opening 40 in the charge housing 28 and is secured therein with a friction fit.

The holding body 64 is hollow and forms a channel 70 leading from the interior of the charge housing 28 up to the membrane 14.

The opening 40 directly points to the membrane 14. The inlet of the channel 70 on the side of the charge housing is, however, preferably closed by an insulation 74 before activation of the gas generator.

Downstream of the membrane 14, the channel 70 ends in a transverse bore 80, which makes a flow connection between the channel 70 and the space 82. The space 82 opens out into the outflow opening 20. Reference number 90 designates a filter plate upstream of the outflow opening 20.

In the charge housing 28, an igniter 36 and a pyrotechnic charge 38 are accommodated, which are spaced apart from the each other by a helical spring 72. The charge 38 could possibly be omitted if the igniter 36 contains sufficient propellant.

As can be readily seen from FIG. 1, the axes A of the outer housing 10 and the axis B of the charge housing 28 are perpendicular to each other and intersect each other.

The holding body 64 has several tasks. Firstly, it serves to provide the previously mentioned channel 70 which directs the produced gas towards the membrane 14, as will be further explained below. A further function consists in securing and/or positioning the charge housing 28, because the holding body 64 at least largely prevents a displacement of the charge housing 28 in the insertion direction, i.e. in the direction of axis B. The holding body 64, however, also serves for positioning the charge housing 28 in the direction of axis A and as a spacer between the charge housing 28 and the membrane 14. This spacer function is important in particular for the manufacture of the gas generator, as will be explained below. After insertion of the charge housing 28 into the sleeve 18, the holding body 64 is in fact, in relation to FIG. 1, introduced into the sleeve 18 via its right-hand, open end face, until the extension 68 has penetrated into the opening 40 and is fastened therein. Then container 16 and membrane holder 15 are inserted into the sleeve 18 in the same direction, until the membrane holder 15 penetrates into a depression in the holding body 64 and abuts against it on the end face. This depression can be constructed as a press fit, loose fit or transition fit. Finally, sleeve 18 and container 16 are connected with each other by rolling, a force occurring through the rolling in the direction of the axis A between the parts. During the rolling process, the container 16 together with the holding body 64 will be pressed against the charge housing 28, the spacing between the membrane 14 and the charge housing 28 remaining constant. Alternatively, of course, the holding body 64 could be pre-mounted on the container 16 or on the membrane holder 15.

The activation of the igniter 36 leads to the burning of the charge 38. The resultant hot gas flows via the opening 40 and the channel 70 to the membrane 14, which is thermally destroyed or weakened to such an extent that it bursts. The compressed gas flows out from the pressure chamber 12 and mixes with the hot gas in the channel 70 and in the space 82, the compressed gas and the hot gas leaving the channel 70 via the transverse bore 80. The gas mixture flows laterally along between the charge housing 28 and the sleeve 18 up to the outflow opening 20, where it leaves the gas generator in axial direction.

The gas generator shown is composed of few parts and has a very simple construction.

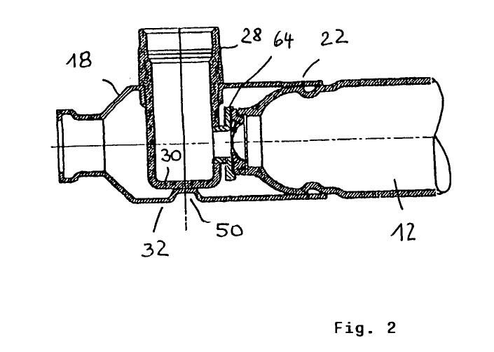

The embodiment according to FIG. 2 corresponds substantially to that according to FIG. 1, for which reason the reference numbers already introduced are used for parts which have an identical function. Therefore, only the differences between the two gas generators are described below.

The fastening of the charge housing 28 on the outer housing 10 does not take place additionally here by means of the press fit in the through-bore 60. The through-bore 60 is in fact not present in this embodiment. Rather, on the section 32 lying opposite the insertion opening 24, a radially inwardly-directed projection 50 is provided in the sleeve 18, on which the end wall 30 of the charge housing 28 is fastened for example by gluing or welding. The projection 50 can possibly also be omitted. Different form-fitting connections or friction-fitting connections can also be provided here.

1. A hybrid gas generator, comprising
a cylindrical outer housing (10) having a longitudinal axis (A),
a pressure chamber (12) filled with compressed gas and closed by a membrane (14),
a pyrotechnic charge (38) provided for opening said membrane (14), said charge (38) being accommodated in a bush-shaped charge housing (28) which has a longitudinal axis (B) arranged substantially at right-angles to said longitudinal axis (A) of said outer housing (10) and extends into said housing (10), and
an outflow opening (20) provided in said outer housing (10), characterized in that
inside said outer housing (10) a separate holding body (64) is provided for retaining said charge housing (28), said holding body (64) being fastened to said charge housing (28) and, additionally, to a part of said gas generator which is not destructed in an activated state of said gas generator.

2. The hybrid gas generator according to claim 1, characterized in that said holding body (64) engages on said charge housing (28) such that it has an effect against a movement thereof in a direction of at least one of said longitudinal axis (B) and said longitudinal axis (A).

3. The hybrid gas generator according to claim 1, characterized in that said pressure chamber (12) has an end wall (17) facing said charge housing (28), said holding body (64) being provided inside said outer housing (10) between said charge housing (28) and said end wall (17).

4. The hybrid gas generator according to claim 1, characterized in that said pressure chamber (12) is defined by a bottle-shaped container (16) with a peripheral wall that forms a section of said outer housing (10) of said gas generator, said container (16) having an end face which forms said end wall (17) adjacent to which said holding body (64) is arranged.

5. The hybrid gas generator according to claim 3, characterized in that said end wall (17) has an opening (19) closed by said membrane (14), said membrane (14) being fastened to a membrane holder (15) which in turn is arranged on said end wall (17).

6. The hybrid gas generator according to claim 5, characterized in that said holding body (64) adjoins said membrane holder (15).

7. The hybrid gas generator according to claim 1, characterized in that part being non-destructed in the activated state of said gas generator is fastened to a container defining said pressure chamber (12).

8. The hybrid gas generator according to claim 1, characterized in that part being non-destructed in the activated state of said gas generator is a membrane holder (15).

9. The hybrid gas generator according to claim 4, characterized by a sleeve (18) which is connected with said peripheral wall of said container (16) and forms a further section of said outer housing (10).

10. The hybrid gas generator according to claim 9, characterized in that an insertion opening (24) is provided in said sleeve (18).

11. The hybrid gas generator according to claim 1, characterized in that said holding body (64) is hollow and forms a channel (70) between said charge housing (28) and said membrane (14), so that gas which leaves said charge housing (28) is directed to said membrane (14).

12. The hybrid gas generator according to claim 1, characterized in that said sleeve (18) has a peripheral wall (22) and said charge housing (28) is fastened on a section (32) of said peripheral wall (22) lying diametrically opposite said insertion opening (24), said fastening having an effect at least against displacement in said direction of said longitudinal axis (A) of said outer housing (10).

13. The hybrid gas generator according to claim 1, characterized in that said charge housing (28) has at least one opening (40) directed to said membrane (14).

14. The hybrid gas generator according to claim 1, characterized in that said outer housing (10) has an axial outflow opening (20) at one axial end.

15. The hybrid gas generator according to claim 1, characterized in that said charge housing (28) is arranged outside said pressure chamber (12).

16. The hybrid gas generator according to claim 1, characterized in that said holding body (64) has at least one of said channels (70) through which gas will flow when said gas generator is activated.
